(19) United States
(12) Patent Application Publication
(10) Pub. No.: US 2019/0299257 A1
(43) Pub. Date: Oct. 3, 2019

(54) CLEANING DEVICE AND CLEANING METHOD

(71) Applicant: NAGASE FILTER Co., Ltd., HIgashiosaka-shi, Osaka (JP)

(72) Inventors: Toshiki EGUCHI, Osaka (JP); Masayoshi SHIMO, Osaka (JP); Hideki HAYASHI, Osaka (JP)

(21) Appl. No.: 16/335,618

(22) PCT Filed: May 26, 2017
(86) PCT No.: PCT/JP2017/019682

§ 371 Date: Mar. 21, 2019

(30) Foreign Application Priority Data
Oct. 31, 2016 (JP) 2016-212413

(51) Int. Cl. B08B 3/12

(52) U.S. Cl. CPC B08B 3/12

(57) ABSTRACT

The present invention provides a novel cleaning device capable of removing deposits on an exposed surface of a cleaning object in a short time. The cleaning device (1) of the present invention, for removing deposits on an exposed surface of a cleaning object (3) includes: a shock-wave generation section (2) that generates a shock wave; and a cleaning object storage section (4) that adjoins the shock-wave generation section (2) or stores the shock-wave generation section (2) therein and stores the cleaning object (3).

### TECHNICAL FIELD

The present invention relates to a cleaning device and a cleaning method.

### BACKGROUND ART

Ultrasonic cleaning devices have conventionally been widely used to clean objects (cleaning objects) (see, e.g., Patent Literature 1).

### CITATION LIST

### Patent Literature

Patent Literature 1: JP 2003-33735 A

### SUMMARY OF INVENTION

### Technical Problem

However, the ultrasonic cleaning devices may take a long time to clean the cleaning objects. In addition, ultrasonic cleaning devices may not physically remove deposits on the exposed surfaces of the cleaning objects.

Accordingly, the present invention is intended to provide a novel cleaning device and cleaning method capable of removing deposits on exposed surfaces of cleaning objects in a short time.

### Solution to Problem

In order to achieve the aforementioned object, the present invention provides a cleaning device for removing a deposit on an exposed surface of a cleaning object, the cleaning device including: a shock-wave generation section that generates a shock wave; and a cleaning object storage section that adjoins the shock-wave generation section or stores the shock-wave generation section therein and stores the cleaning object.

The present invention further provides a cleaning method including: a shock-wave generation step of generating a shock wave; and a cleaning step of causing the shock wave to impinge a cleaning object to remove a deposit on an exposed surface of the cleaning object.

### Advantageous Effects of Invention

The cleaning device and the cleaning method of the present invention can remove deposits on exposed surfaces of cleaning objects in a short time.

### BRIEF DESCRIPTION OF DRAWING

FIG. 1 is a cross-sectional view showing an exemplary configuration of the cleaning device of the present invention.

### DESCRIPTION OF EMBODIMENTS

In the present invention, the “exposed surface” may be, for example, any surface that is exposed to the outside and that can contact with, for example, a liquid and a gas.

In the present invention, the “shock wave” is, for example, a wave of pressure change that travels at a speed exceeding the speed of sound. In the present invention, there is no particular limitation on the means for generating the shock wave and the method for generating the shock wave, and for example, the means may be an explosive such as groundpowder, and the shock wave may be generated by explosion thereof. Alternatively, the means may be a pair of electrodes, and the shock wave may be generated by discharge such as pulsed discharge using the electrodes.

In the cleaning device of the present invention, the cleaning object storage section may be filled with water, and the shock wave may propagate through the water within the cleaning object storage section. In the cleaning method of the present invention, the shock wave may propagate through water in the cleaning step.

In the cleaning device and the cleaning method of the present invention, the cleaning object may be at least one selected from the group consisting of reticulated bodies, porous bodies, and cylindrical bodies. In this instance, the cleaning object may be at least one selected from the group consisting of filters, screens, separating membranes, dialyzing membranes, ion exchange membranes, activated carbon, diatomaceous earth, silica sand, anthracite, ion exchangers, pipes, joints, valves, and pumps.

In the cleaning device and the cleaning method of the present invention, the cleaning object may be at least one of a metallic product or a metallic part. In this instance, the cleaning object may be at least one selected from the group consisting of demisters, Sluzer, housings, containers, tanks, heat-exchange elements, scrubbers, boilers, turbines, propellers, shafts, tableware, and substrates.

An embodiment of the present invention is described below with reference to a drawing. The present invention, however, is by no means limited thereto. In the drawing, for convenience of explanation, the structure of each part may be shown in a simplified manner as appropriate, and the dimensional ratio and the like of each part may be different from actual ones.

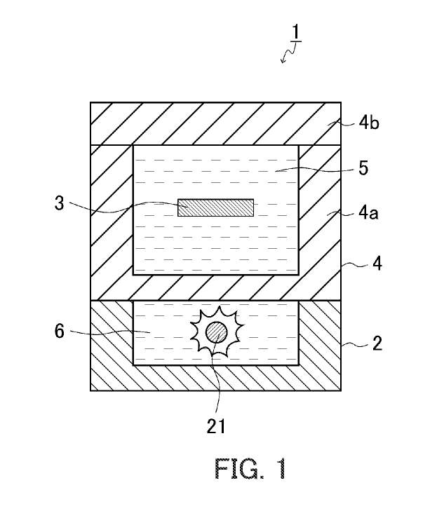

FIG. 1 is a cross-sectional view showing an exemplary configuration of the cleaning device of the present invention. As shown in FIG. 1, the cleaning device 1 includes: a shock-wave generation section 2; and a cleaning object storage section 4.

The shock-wave generation section 2 generates a shock wave. In this embodiment, the shock-wave generation section 2 has a box shape with one side (upper side in FIG. 1) opened. However, the shape of the shock-wave generation section 2 is not limited to particular shapes and may not have a box shape. The material for forming the shock-wave generation section 2 is not limited to particular materials, and examples thereof include resins; and metals such as aluminum, copper, copper alloys, iron, iron alloys, nickel, tungsten, and tungsten alloys.

The shock-wave generation section 2 may be filled with a transfer medium 6 for propagating the shock wave. As the transfer medium 6, for example, any of liquids such as water; elastomers such as rubbers, solids such as gelled objects; gases such as air; or mixtures thereof may be used. Among these, liquid or solid is preferable from the viewpoint of the shock wave transfer property, and water is preferable because it is inexpensive and easily available.

The cleaning device 1 of the present embodiment includes, in the shock-wave generation section 2, an explosive 21 such as groundpowder, which generates the shock wave by an explosion. The explosive 21 is disposed at a predetermined position by a support member (not shown) in the shock-wave generation section 2 (in the transfer medium 6), for example. The explosive 21 is configured to be detonated, for example, by an electric detonator. As the explosive 21, for example, an explosive having an appropriate shape such as a spherical shape, a rod shape, or a plate shape and an appropriate size is used. Although only one explosive 21 is shown in FIG. 1, a plurality of explosives 21 may be used depending on, for example, the volume of the shock-wave generation section 2. When a plurality of explosives are used, the shock wave may be continuously generated by detonating the respective explosives 21 at different timings.

In FIG. 1, the explosive 21 is exemplified as the means for generating the shock wave, but the present invention is not limited thereto. As described above, in the present invention, there is no particular limitation on the means for generating the shock wave and the method for generating the shock wave, and for example, the means may be a pair of electrodes, and the shock wave may be generated by a discharge such as pulsed discharge using the electrodes. Alternatively, for example, the means may be a striking means such as a hammering member, and the shock wave may be generated by applying a mechanical shock force to the cleaning object storage section 4 using the striking means. In these cases, the discharge or the strike may be performed once or a plurality of consecutive times.

The cleaning object storage section 4 stores a cleaning object 3. The cleaning object storage section 4 can be formed using, for example, the same material as that exemplified as a material for forming the shock-wave generation section 2. The cleaning object storage section 4 may be filled with a transfer medium 5 for propagating the shock wave. As the transfer medium 5, for example, the same medium as that exemplified as a transfer medium 6 can be used. The transfer media 5 and 6 may be the same as or different from each other.

In this embodiment, the cleaning object storage section 4 has a box 4a with one side (upper side in FIG. 1) opened and a lid 4b for closing the opening of the box 4a, and the inside is sealed. The upper opening of the box 4a, to be closed by the lid 4b, is used to move the cleaning object 3 in and out. However, the cleaning object storage section 4 is only required to store the cleaning object 3 and to be sealed, and the form of the cleaning object storage section 4 is not limited to particular forms.

FIG. 1 shows a cleaning device 1 where the shock-wave generation section 2 and the cleaning object storage section 4 adjoin each other so as to close the upper opening of the shock-wave generation section 2. The present invention, however, is by no means limited thereto. The shock-wave generation section 2 may be stored inside the cleaning object storage section 4 when the shock-wave generation section 2 is to generate a shock wave by, for example, an explosion of the explosive or discharges using electrodes as mentioned above.

The cleaning object 3 is only required to have an exposed surface to which deposits to be removed are adhered and may be any object. Examples of the cleaning object 3 include reticulated bodies, porous bodies, and cylindrical bodies. Examples of the reticulated bodies include filters and screens. Examples of the porous bodies include separating membranes, dialyzing membranes, ion exchange membranes, activated carbon, diatomaceous earth, silica sand, anthracite, and ion exchangers. Examples of the cylindrical bodies include pipes, joints, valves, and pumps. The cleaning object 3 may be, for example, an object falling under at least two of the reticulated body, the porous body, and the cylindrical body. When the cleaning object 3 is, for example, a filter medium or a pipe for a fluid such as molten resin or a viscous fluid, such as a filter or a pipe, the deposit may be, for example, a resin and a scale retained on an exposed surface of the cleaning object 3. When the cleaning object 3 is, for example, a porous body such as activated carbon or diatomaceous earth, the deposit may be a substance adsorbed in the pores.

Examples of the cleaning object 3 include metallic products and metallic parts. The metallic products and the metallic parts may be formed entirely of metal, or may include a part formed partially of a material other than metal, for example. Specific examples of the metallic products and the metallic parts include demisters, Sluzer, housings, containers, tanks, heat-exchange elements, scrubbers, boilers, turbines, propellers, shafts, tableware, and substrates. In these cases, the deposit may be, for example, any of sludge such as rust, organic contaminants, scales, and cutting chips. The housings, containers, tanks, shafts, tableware, and substrates are not limited to those made of metal and may be formed of other materials such as plastic, ceramics, and carbon fiber. The filters, screens, pipes, joints, valves, and pumps may also be made of metal, or may be formed of other materials such as plastic, ceramics, and carbon fiber.

The cleaning object 3 is stored in place in the cleaning object storage section 4 by, for example, a support member (not shown). The cleaning object 3 stored in the cleaning object storage section 4 may be placed in a protective material such as a vinyl bag or a polyethylene-made bag, for example. When the cleaning object 3 is, for example, granular activated carbon, the cleaning object 3 may be stored in, for example, a container capable of propagating the shock wave.

In FIG. 1, the number of cleaning objects 3 is one, but this is illustrative and the present invention is not limited thereto. A plurality of cleaning objects 3 may be simultaneously stored in the cleaning object storage section 4. In the case where the cleaning object 3 is stored in place in the cleaning object storage section 4 by, for example, the support member as mentioned above, even if a plurality of cleaning objects 3 are used, the cleaning objects 3 can be prevented from contacting with one another in the cleaning object storage section 4.

Next, the cleaning method of the present invention will be described by way of example. The cleaning method of the present invention can be carried out, for example, using the cleaning device of the present invention. Here, an example of the cleaning method of the present invention will be described with reference to an example in which the cleaning device shown in FIG. 1 is used.

First, the impact force caused by the explosion of the explosive 21 is transmitted to the cleaning object storage section 4 as a shock wave through the transfer medium 6 in the shock-wave generation section 2. The shock wave propagates through the transfer medium 5 in the cleaning object storage section 4 and impinges on a cleaning object 3 (e.g., a filter). By the impact of the shock wave on the cleaning object 3, deposits on the exposed surface of the cleaning object 3 (e.g., resins retained on the exposed surface of the filter) are crushed and diffused into the transfer medium 5 and removed. The transfer medium 5 may be replaced as appropriate depending on the extent of contamination due to diffusion of the deposits.

The cleaning device and the cleaning method of the present invention can remove deposits on the exposed surface of the cleaning object in a shorter time by using the shock wave, as compared with the ultrasonic cleaning device. In addition, the cleaning device and the cleaning method of the present invention can remove, by using the shock wave, deposits on the exposed surface of the cleaning object, which cannot be physically removed by the ultrasonic cleaning device.

### INDUSTRIAL APPLICABILITY

As described above, the cleaning device and the cleaning method of the present invention can remove deposits on the exposed surface of the cleaning object in a short time. The applications of the cleaning device and the cleaning method of the present invention are not limited to particular applications, and the cleaning device and the cleaning method of the present invention can be widely used, for example, for cleaning of cleaning objects such as reticulated bodies, porous bodies, and cylindrical bodies.

Although the present invention has been described above with reference to the embodiments, the present invention is not limited to the above-described embodiments. Various modifications can be made to the structure and details of the present invention which can be understood by those skilled in the art within the scope of the present invention.

The present application claims priority to Japanese Patent Application No. 2016-212413, filed on Oct. 31, 2016, the entire disclosure of which is incorporated herein by reference.

### REFERENCE SIGNS LIST

1 Cleaning device
2 Shock-wave generation section
3 Cleaning object
4 Cleaning object storage section
5, 6 Transfer medium
21 Explosive

1. A cleaning device for removing a deposit on an exposed surface of a cleaning object, the cleaning device comprising:
a shock-wave generation section that generates a shock wave; and
a cleaning object storage section that adjoins the shock-wave generation section or stores the shock-wave generation section therein and stores the cleaning object.

2. The cleaning device according to claim 1, wherein
the cleaning object storage section is filled with water, and
the shock wave propagates through the water within the cleaning object storage section.

3. The cleaning device according to claim 1, wherein
the cleaning object is at least one selected from the group consisting of reticulated bodies, porous bodies, and cylindrical bodies.

4. The cleaning device according to claim 3, wherein
the cleaning object is at least one selected from the group consisting of filters, screens, separating membranes, dialyzing membranes, ion exchange membranes, activated carbon, diatomaceous earth, silica sand, anthracite, ion exchangers, pipes, joints, valves, and pumps.

5. The cleaning device according to claim 1, wherein the cleaning object is at least one of a metallic product or a metallic part.

6. The cleaning device according to claim 5, wherein
the cleaning object is at least one selected from the group consisting of demisters, housings, containers, tanks, heat-exchange elements, scrubbers, boilers, turbines, propellers, shafts, tableware, and substrates.

7. A cleaning method comprising:
a shock-wave generation step of generating a shock wave; and
a cleaning step of causing the shock wave to impinge a cleaning object to remove a deposit on an exposed surface of the cleaning object.
